(19) United States
(12) Patent Application Publication
(10) Pub. No.: US 2010/0253016 A1
(43) Pub. Date: Oct. 7, 2010

(54) COLLET ADAPTER

(75) Inventors: Don Terwilliger, Elmira, NY (US); Chun Samuel Zhang, Wellsville, NY (US); Joseph T. Covin, Horseheads, NY (US); Uwe Marquart, Bodman Ludwigshafen (DE)

Correspondence Address: PILLSBURY WINTHROP SHAW PITTMAN, LLP, P.O. BOX 10500, MCLEAN, VA, 22102, US

(73) Assignee: Hardinge, Inc., Elmira, NY (US)

(21) Appl. No.: 12/416,774

(22) Filed: Apr. 1, 2009

(51) Int. Cl. B23B 31/02; B23P 11/00

(52) U.S. Cl. 279/143; 29/428

(57) ABSTRACT

A collet adapter includes a spindle adapter body configured to removably mount to a non-collet-ready spindle of a machine (e.g., a lathe or machining center). The spindle adapter body has a collet seat configured to mate with a collet. The adapter also includes an adapter collar configured to removably mount to the spindle adapter. When the collar is mounted to the adapter body, it facilitates secure attachment of a device with a spindle mount to the machine via an enlarged mounting shoulder of the collar. The collar can be removed to provide improved radial access to a work piece being held by the spindle adapter body and a non-step collet.

### BACKGROUND OF THE INVENTION

1. Field of the Invention

The present invention relates generally to workholding devices, and relates specifically to collet adapters for metal machining.

2. Description of Related Art

Work pieces (e.g. metal pieces such as bar stock) typically mount to a spindle of a metal working machine using a chuck that incorporates jaws that grip the work piece. As shown in FIG. 4, Hardinge developed metal cutting machines 1000 with a hollow spindle 1010 with a collet seat 1010a into which a collet 1020 is inserted. This collet-ready spindle 1010 is provided within a workhead of the machine, which provides high accuracy. A collet 1020 mounts to an actuating device 1030 (e.g., drawbar) such that axial movement of the actuating device 1030 opens and closes the collet 1020 to grip a work piece 1040. The hollow diameter of the spindle 1010 constrains the size of work piece that a collet system can hold.

If a machine with a spindle designed to accept collets is to machine (e.g., grind, finish grind, polish, mill, turn, engrave) a work piece larger than the constraining hollow diameter of the spindle, a step chuck may be used. FIGS. 5 and 6 illustrate an exemplary step chuck assembly 1050 that may be mounted to the nose of the spindle 1010 illustrated in FIG. 4 in place of the standard collet 1020. The step chuck assembly 1050 includes a step chuck closer 1060 that mounts to the nose of the spindle 1010 via bolts or another suitable fastening mechanism. The step chuck assembly 1050 also includes a step collet 1070 that mounts to the actuating device 1030 in place of the collet 1020. The closer 1060 and step collet 1070 have mating cam surfaces such that axial movement of the step collet 1070 relative to the closer 1060 causes the step collet 1070 to open and close.

When it is desired to use a collet in a machine whose spindle is not adapted to accept a collet (known as a non-collet-ready spindle), a collet adapter is used. FIG. 7 illustrates a conventional collet adapter 1100 (also conventionally known as a collet adaptation chuck). The collet adapter 1100 includes a spindle adapter body 1110 that is bolted or otherwise rigidly secured to the spindle of the machine. The adapter 1100 also includes a link-up adapter 1120 that has a drawbar mount 1120a designed to attach to an actuating device (e.g., a drawbar) of the machine (e.g., via a threaded connection as shown). The link-up adapter 1120 also includes a collet mount 1020b that is adapted to attach to the collet 1020 (e.g., via a threaded connection, a bayonet connection, etc. depending on the type of collet system being used (e.g., Hardinge “C” style collet, 3J collet, etc.)).

The step chuck assembly 1050 of FIG. 5 may be mounted to the collet adapter 1100 in place of the collet 1020 in the same manner that the collet adapter 1100 can be mounted to the spindle 1010. A forward face/mount 1110a the spindle adapter body 1110 (see FIG. 7) mates with a rearward face/spindle mount 1060a (see FIG. 6) of the closer 1060. As shown in FIG. 7, the forward face 1110a extends significantly radially outwardly to facilitate a secure, high accuracy, high precision connection between the collet adapter 1100 and the closer 1060. The step collet 1070 is then attached to the link-up adapter 1120.

As can be appreciated from FIG. 7, the large radial extension of the forward step chuck mounting face 110a of the spindle adapter body 1110 may interfere with tool clearance on a tooling turret when a standard, non-step collet 1020 is used in the collet adapter 1100.

### SUMMARY OF EMBODIMENTS OF THE INVENTION

One or more embodiments of the present invention improves tool clearance by providing a collet adapter that incorporates a removable annular collar. The collar may be removed to improve tool accessibility to a work piece held in the collet 1020. Conversely, the collar may be attached to provide a stable support and attachment point for a step chuck closer 1060.

One or more embodiments of the invention provides a collet adapter that includes a spindle adapter body having a spindle mount configured to removably mount to a spindle of a machine. The spindle adapter body has a collet seat with a tapered cam surface configured to mate with a collet. The collet adapter also includes an adapter collar configured to removably mount to the spindle adapter body. The collar has a mounting shoulder configured to removably mount to and support a workholding device.

According to one or more of these embodiments, the collet adapter comprises a spindle nose when the collar is mounted to the spindle adapter body, the mounting shoulder of the collar defining at least a portion of the spindle nose.

According to one or more of these embodiments, the spindle nose comprises an ANSI spindle nose.

According to one or more of these embodiments, there is greater radial tool access to a nose portion of the spindle adapter body when the collar is removed from the spindle adapter body than when the collar is mounted to the adapter body.

According to one or more of these embodiments, the mounting shoulder comprises a step collet mounting shoulder that is configured to removably mount to and support a spindle mount of a step chuck closer that includes a tapered cam surface of a larger size than the tapered cam surface of the collet seat.

According to one or more of these embodiments, the mounting shoulder has a larger diameter than a nose portion of the spindle adapter.

According to one or more of these embodiments, a portion of the collar extends farther forward than or farther radially outward than any point on the spindle adapter body when the collar is mounted to the spindle adapter body.

According to one or more of these embodiments, the mounting shoulder extends either farther forward than or farther radially outward than any point on the spindle adapter body when the collar is mounted to the spindle adapter body.

According to one or more of these embodiments, the spindle adapter body comprises a nose portion that extends farther forward than the collar when the collar is mounted to the spindle adapter body.

According to one or more of these embodiments, the spindle adapter body and collar have radial through holes that align when the collar is mounted to the spindle adapter body.

According to one or more of these embodiments, the collar comprises a step chuck closer mount configured to removably mount to a step chuck closer; the step chuck closer mount includes the mounting shoulder; and the step chuck closer mount comprises a plurality of bolt holes in the mounting shoulder. According to one or more of these embodiments, the plurality of bolt holes are positioned in an A2-x mounting pattern and are each threaded.

According to one or more of these embodiments, the spindle adapter body and collar comprise a mated pair that are specifically manufactured for use with each other.

According to one or more of these embodiments, the spindle adapter body and collar each have indicia indicating that they are a mated pair.

According to one or more of these embodiments, the spindle adapter body and collar are configured to only mount to each other in a single, predetermined, relative pivotal position about a longitudinal axis of the collet adapter.

One or more embodiments of the present invention provides a collet adapter according to one or more of these embodiments, in combination with a step chuck assembly. The step chuck assembly includes a step chuck closer mounted to the collar, the step chuck closer comprising a cam surface; and a step collet, the step collet having a cam surface that mates with the cam surface of the step chuck. The collar is mounted to the spindle adapter body.

According to one or more of these embodiments, the collet seat comprises a C style collet seat.

According to one or more of these embodiments, the spindle mount of the spindle adapter body comprises an ANSI spindle mount.

According to one or more of these embodiments, the collar has an axial length of at least ½ inch.

According to one or more of these embodiments, the spindle adapter body comprises a machine spindle mount configured to removably and securely mount to a spindle of a machine, and a collar mount. The collar may comprise an adapter body mount that is configured to removably and securely mount to the collar mount of the spindle adapter body.

According to one or more of these embodiments, the collar mount comprises at least one bolt hole in the adapter body. The adapter body mount comprises at least one bolt hole in the collar. The at least one bolt hole in the collar may be configured to align with the at least one bolt hole in the adapter body when the collar is disposed in a mounting position relative to the adapter body to facilitate at least one bolt extending into the at least one bolt hole in the adapter body and the at least one bolt hole in the collar.

One or more embodiments of this invention provides a collet adapter that includes a spindle adapter body having a spindle mount configured to removably mount to a spindle of a machine. The spindle adapter body has a collet seat with a tapered cam surface configured to mate with a collet. The collet adapter also includes an adapter collar configured to removably mount to the spindle adapter body, the collar having a mounting shoulder. When the adapter collar is mounted to the spindle adapter body, the adapter forms a spindle nose for mounting a spindle mount of a device thereto, the mounting shoulder of the collar forming at least a part of the spindle nose.

According to one or more of these embodiments, the spindle adapter body itself does not form a spindle nose for mounting a spindle mount thereto.

According to one or more of these embodiments, the spindle nose comprises an ANSI spindle nose. When the adapter collar is mounted to the spindle adapter body, the mounting shoulder of the collar forms at least a part of the ANSI spindle mount. The spindle adapter body itself does not form an ANSI spindle nose.

According to one or more of these embodiments, the ANSI spindle nose comprises an A2-x spindle nose. The collar has an A2-x bolt hole pattern in its forward face. The A2-x bolt hole pattern defines a portion of the A2-x spindle nose. A nose portion of the spindle adapter body has a frusta-conical surface that defines a portion of the A2-x spindle nose.

One or more embodiments of this invention provides a method of manufacturing a collet adapter that comprises a spindle adapter body having a spindle mount configured to removably mount to a spindle of a machine. The spindle adapter body has a collet seat with a tapered cam surface configured to mate with a collet. The collet adapter also includes an adapter collar configured to removably mount to the spindle adapter body. The collar has a mounting shoulder configured to removably mount to and support a workholding device. The method comprises machining a forward axial face of the collar to form the shoulder while the collar is mounted to the spindle adapter body.

According to one or more of these embodiments, the method further comprises putting the spindle adapter body and collar together for use or sale as a matched pair.

According to one or more of these embodiments, the method further comprises, while the collar is mounted to the spindle adapter body, machining a tapered surface of the spindle adapter body, the machined tapered surface being configured to work in conjunction with the shoulder to properly locate a workholding device on the collet adapter.

One or more embodiments of this invention provides a method of using a collet adapter that comprises a spindle adapter body configured to removably mount to a spindle of a machine, the a spindle adapter body having a spindle mount configured to removably mount to a spindle of a machine, the spindle adapter body having a collet seat with a tapered cam surface configured to mate with a collet; and an adapter collar configured to removably mount to the spindle adapter body, the collar having a mounting shoulder configured to removably mount to and support a workholding device. The method comprises mounting the spindle adapter body to a spindle of a machine. The method also comprises, while the collar is not mounted to the spindle adapter body, using the machine to machine a first work piece while the first work piece is mounted to a collet that is mounted to the spindle adapter. The method also comprises, while the collar is mounted to the spindle adapter body, using the machine to machine a second work piece while the second work piece is mounted to a workholding device that is mounted to the collar.

According to one or more of these embodiments, the workholding device comprises a step chuck assembly that includes a step chuck closer with a tapered cam surface that has a larger diameter than the tapered cam surface of the collet seat of the spindle adapter body.

According to one or more of these embodiments, the method further comprises, using the machine to machine the first work piece comprises using the machine in a manner that would create a physical interference with the collar if the collar were mounted to the spindle adapter body.

These and other aspects of various embodiments of the present invention, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. In one embodiment of the invention, the structural components illustrated herein are drawn to scale. It is to be expressly understood, however, that the drawings are for the purpose of illustration and description only and are not intended as a definition of the limits of the invention. In addition, it should be appreciated that structural features shown or described in any one embodiment herein can be used in other embodiments as well. As used in the specification and in the claims, the singular form of “a”, “an”, and “the” include plural referents unless the context clearly dictates otherwise.

### BRIEF DESCRIPTION OF THE DRAWINGS

For a better understanding of embodiments of the present invention as well as other objects and further features thereof, reference is made to the following description which is to be used in conjunction with the accompanying drawings, where:

FIG. 1 is a cross-sectional side view of a collet adapter according to an embodiment of the present invention;

FIG. 2 is a cross-sectional side view of a spindle adapter body of the collet adapter illustrated in FIG. 1;

FIG. 3 is a front view of an adapter collar of the chuck illustrated in FIG. 1;

FIG. 4 is a cross-sectional side view of a conventional metal working machine with a collet-ready spindle;

FIG. 5 is a perspective view of a conventional step chuck assembly;

FIG. 6 is a side cross-sectional view of a step chuck closer of the assembly of FIG. 5;

FIG. 7 is a side, partial cross-sectional view of a conventional collet adapter; and

FIG. 8 is a cross-sectional side view of a collet adapter according to an alternative embodiment of the present invention.

### DETAILED DESCRIPTION OF EXEMPLARY EMBODIMENTS OF THE INVENTION

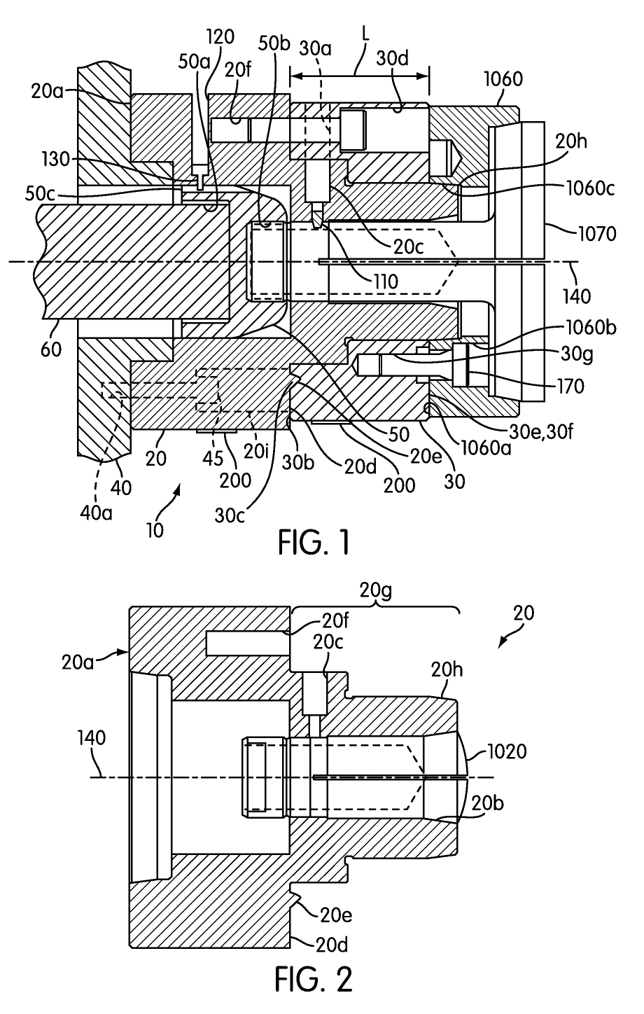

FIGS. 1-3 illustrate a collet adapter 10 according to an embodiment of the present invention. The collet adapter 10 comprises a spindle adapter body 20 and an annular adapter collar 30.

As shown in FIG. 1, the spindle adapter body 20 includes a machine spindle mount 20a at its rearward end for secure, high accuracy mounting of the spindle adapter body 20 to a non-collet-ready spindle 40 of an underlying machine (e.g., a lathe, milling machine, machine center, etc.). The illustrated machine spindle mount 20a comprises a frustoconical inner surface that is adapted to mate with a corresponding frustoconical outer surface of the machine's spindle 40 to precisely and accurately locate the body 20 relative to the spindle 40. The machine spindle mount 20a also includes a plurality of bolt holes 20i through which bolts 45 extend. The bolts 45 further extend into threaded holes 40a in the spindle 40 to secure the body 20 to the spindle 40. Alternatively, any other suitable machine spindle mount 20a may be used, depending on the type of machine to which the adapter 10 is to be attached (e.g., a threaded connection and a locking radial bolt).

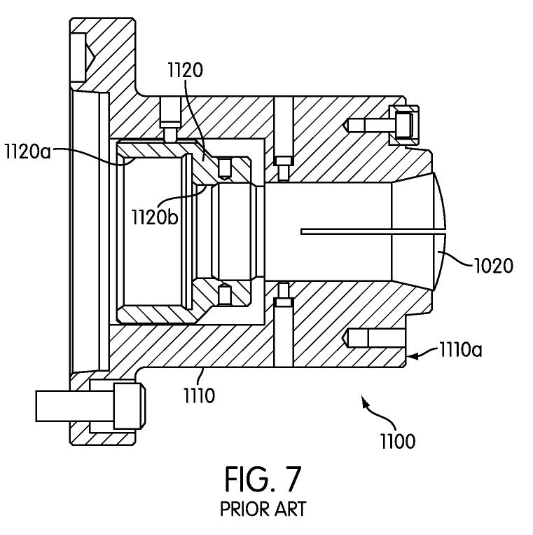

In the illustrated embodiment, the bolt holes 20i extend through the main body of the spindle adapter body 20, and the front ends of the holes 20i are covered by the collar 20. Alternatively, the bolt holes 20i may extend through a flange on the body 20 in the same manner as illustrated in FIG. 7 with respect to a conventional collet adapter 1100.

According to various embodiments of the present invention, the machine spindle mount 20a comprises an ANSI A2-x spindle mount (e.g., A2-4, A2-5, A2-6, A2-8, A2-11), an ANSI A1-x spindle mount, an ANSI B1-x spindle mount, an ANSI B2-x spindle mount, or any other suitable spindle mount. The machine spindle mount 20a has the corresponding mounting surface (e.g., flat and frusta-conical surfaces) and bolt hole pattern (e.g., number, size, and location) of the specific spindle mount being used (e.g., A2-x sized mounting shoulder and frusta-conical surface and A2-x bolt hole pattern). The sizes and dimensions for various of these spindle mounts are provided in ANSI Standard B5.9-1967 Spindle Noses for Tool Room Lathes, Engine Lathes, Turret Lathes and Automatic Lathes, the entire content of which is incorporated by reference herein. Alternatively, any other suitable mount 20a may be used depending on the type of machine to which it is to be mounted (e.g., non-standard spindles, standard spindles in any country, etc.). A spindle nose of the machine spindle 40 has a corresponding size/shape (e.g., ANSI A2-x spindle nose).

The adapter body 20 also includes a collet seat 20b in the form of an axially extending opening in the body 20. A forward end of the collet seat 20b includes a tapered/frustoconical cam surface adapted to mate with a corresponding cam surface of the collet 1020.

In the illustrated embodiment, the spindle adapter body 20 comprises a single, integral piece of material (e.g., a machined piece of steel). However, according to alternative embodiments of the present invention, the spindle adapter body 20 comprises a plurality of discrete portions that are fastened to each other (e.g., via bolts, welds, etc.).

As shown in FIG. 1, the adapter 10 also includes a link-up adapter 50 that may be generally identical to the above described link-up adapter 1120. The link-up adapter 50 includes a drawbar mount 50a constructed to attach to a drawbar/actuating device 60 of the machine. In the illustrated embodiment, the drawbar mount 50a comprises internal threads adapted to threadingly engage corresponding external threads of the drawbar 60.

The link-up adapter 50 also includes a collet mount 50b that is adapted to attach to the collets 1020, 1070. In the illustrated embodiment, the collet mount 50b comprises internal threads adapted to threadingly engage corresponding external threads of the collets 1020, 1070. However, any suitable collet mount may be used without deviating from the scope of the present invention, depending upon the type of collet to be mounted (e.g., external threads to mate with internal threads of a collet, a bayonet connection, a mount for the Hardinge “C” style collet, 3J collet, 22J collet, etc.).

According to various embodiments of the invention, the link-up adapter 50 may be omitted entirely (e.g., in machines in which the collet can directly mount to the drawbar 60 or indirectly mount to a drawbar via a mechanism other than a link-up adapter).

As shown in FIG. 1, the adapter body 20 comprises a radial hole 20c that is at least partially threaded, and the collar 30 comprises a radial hole 30a that aligns with the hole 20c when the collar 30 is mounted to the adapter body 20. A bolt, set screw, or other fastener 110 selectively extends through the hole 20c and is accessible via the hole 30a. The fastener 110 extends into a keyway in the step collet 1070 or collet 1020 to selectively prevent the collet 1020, 1070 from rotating relative to the adapter body 20. To attach a collet 1020, 1070 to a non-rotating link-up adapter 50 and non-rotating drawbar 60, the collet 1020, 1070 is rotated to thread the collet 1020, 1070 onto the link-up adapter 50. The fastener 110 is then threaded into the hole 20c such that it extends into an axial keyway in the collet 1020, 1070 to prevent the collet 1020, 1070 from rotating and disengaging from the link-up adapter 50.

Conversely, in a machine in which the drawbar 60 and link-up adapter 50 are designed to rotate relative to the spindle 40, the fastener 110 may be permanently mounted to the spindle adapter body 20 such that it always extends into the collet seat 20b. To attach a collet 1020, 1070, the collet 1020, 1070 is moved axially into the collet seat 20b such that its keyway aligns with the fastener 110, and the drawbar 60 and link-up adapter 50 are rotated to thread the collet 1020, 1070 into the link-up adapter 50.

As shown in FIG. 1, the adapter body 20 comprises a partially threaded radial hole 120 into which a fastener 130 selectively fits to selectively prevent the link-up adapter 50 from rotating relative to the adapter body 20. The fastener 130 extends into a keyway 50c in the link-up adapter 50 to selectively prevent rotation of the link-up adapter 50 to facilitate connection of the link-up adapter to the drawbar 60 and/or collet 1020, 1070.

As shown in FIG. 1, the collar 30 is configured to securely and removably mount to the spindle adapter body 20. The collar 30 comprises a spindle adapter body mount 30b that mates with a collar mount 20d of the spindle adapter body 20. In the illustrated embodiment, the mounts 20d, 30b comprising mating surfaces that facilitate a precise, accurate, easily repeatable connection between the collar 30 and the spindle adapter body 20. The mounts 20d, 30b comprise a feature (e.g., mating, surface features 20d, 30c that are non-rotationally-symmetric about a rotational axis 140 of the adapter 10; bolt holes that only align with each other in one pivotal position of the collar 30 relative to the adapter body 20 about the axis 140; etc.) that ensure that the collar 30 can only mount to the adapter body 20 in a single, predetermined, relative pivotal position about a longitudinal axis 140 of the collet adapter 10. As shown in FIGS. 1-3, the mounts 20d, 30d comprise a plurality of circumferentially spaced, aligning bolt holes 20f, 30d. The holes 20f, 30d may be evenly circumferentially spaced, or may be unevenly circumferentially spaced to ensure that the collar 30 only mounts to the body 20 in a predetermined rotational position in which all of the holes 30d align with all of the holes 20f. The holes 20f are threaded. The holes 30d include a large ID forward portion and a smaller ID rearward portion, the intersection of which defines a shoulder against which the head of a bolt 150 can be supported. Bolts 150 axially extend through the holes 30d and threadingly engage the holes 20f to securely and removably attach the collar 30 to the spindle adapter body 20.

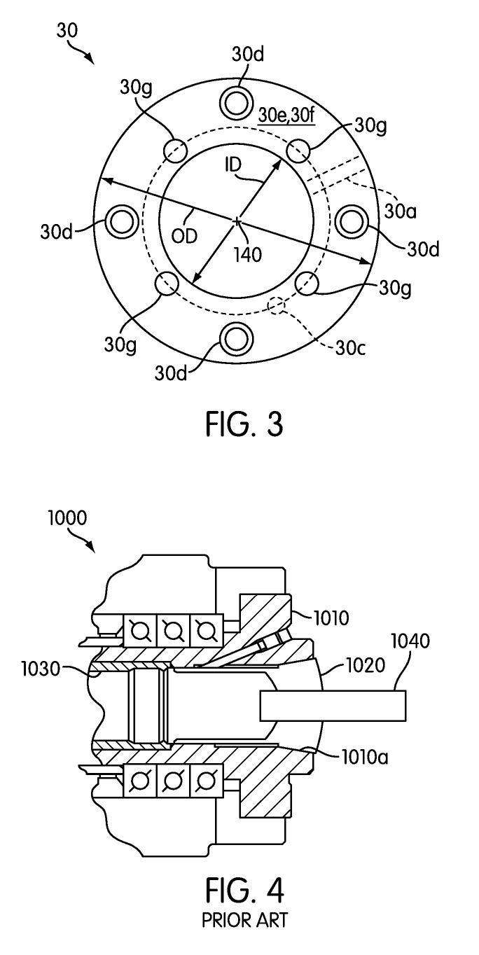

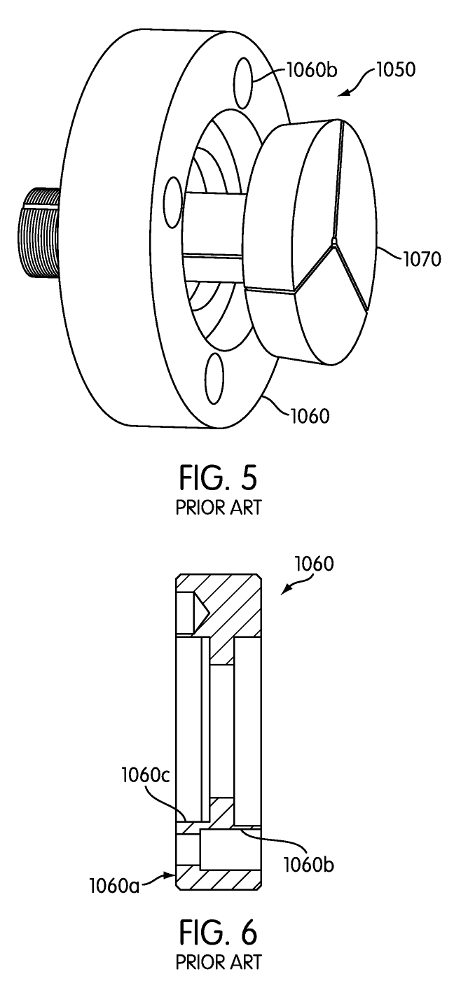

As shown in FIG. 1, the collar 30 is configured to mount to and support the step chuck closer 1060. The collar 30 includes a mounting surface 30e. The mounting surface 30e is configured to removably and securely mount to various workholding devices (e.g., a spindle mount 1060a of the step chuck closer 1060 (as shown in FIG. 1), jaw chucks, diaphragm chucks, magnetic chucks, face plates, etc.). As shown in FIGS. 1-3, the mounting surface 30e comprises a forward mounting shoulder 30f that has a larger diameter than a nose portion 20g of the adapter body 20 and a forward face of the nose portion 20g. As shown in FIGS. 1 and 3, the mounting surface 30e comprises a plurality of circumferentially spaced, threaded, bolt holes 30g in the shoulder 30f. The holes 30g align with bolt holes 1060b of the spindle mount 1060a of the step chuck closer 1060. As shown in FIG. 1, bolts 170 axially extend through the holes 1060b and threadingly engage the holes 30g to securely and removably mount the step chuck closer 1060 to the collar 30. The large diameter of the mating surfaces of the mounts 30e, 1060a provide a secure, high precision and accuracy connection between the step chuck assembly 1050 (or other workholding device) and the collar 30, spindle adapter body 20, and attached machine.

As shown in FIG. 1, when the collar 30 is mounted to the spindle adapter body 20, a portion of the collar 30 extends farther forward than or farther radially outward than any portion of the spindle adapter body 20. When the collar 30 is mounted to the spindle adapter body 20, the forward mounting shoulder 30f extends either farther forward than or farther radially outward than any point on the spindle adapter body 20. When the collar 30 is mounted to the spindle adapter body 20, the nose portion 30g of the spindle adapter body 20 extends farther forward than the collar 30.

As shown in FIGS. 1 and 2, the spindle adapter body 20 includes a frustoconical surface 20h on its nose portion 20g. The surface 20h is configured to mate with a corresponding frustoconical surface 1060c of the step chuck closer 1060 (or other workholding device) to facilitate a high precision and accuracy connection between the step chuck closer 1060 (or other workholding device) and the collet adapter 10.

Together, the shoulder 30f and surface 20h form a mounting face/spindle nose configured to mate with the step chuck closer 1060 (or other workholding devices such as jaw chucks, diaphragm chucks, magnetic chucks, face plates, etc. or any other type of device that is desirably mountable to the adapter 10). For example, the shoulder 30f and surface 20h may form a spindle nose having the shape of an A2-x spindle nose, an A1-x spindle nose, a B1-x spindle nose, a B2-x spindle nose, or any other type of ANSI, standard, or non-standard spindle nose (e.g., any of the spindle types of the underlying machine spindle) to facilitate attachment of a workholding device with a complimentary spindle mount. The holes 30d in the collar 30 may have a number, size, circumferential spacing, and distance from the axis 140 based on the spindle nose type selected. The spindle nose type formed by the collar 30 and front end of the spindle adapter body 20 may be the same as or different than the spindle nose type of the underlying machine spindle 40.

The surfaces 1060a, 1060c and bolt holes 1060b of the step chuck closer 1060 (or other workholding device or other type of device with a spindle mount) define a spindle mount that mates with the spindle mount formed by the collar 30 and spindle adapter body 20. For example, the step chuck closer 1060 may define an A2-x, A1-x, B1-x, or B2-x spindle mount, or any other suitable spindle mount for mounting to the collar 30 and spindle adapter body 20.

According to various embodiments of the present invention (and depending, according to various embodiments, on the type of spindle mount to be included in the step closer 1060), the collar 30 has an inside diameter ID (shown in FIG. 3) and an outside diameter OD. According to various embodiments, ID is larger than 1 inch, 2 inches, 3 inches, 4 inches, 5 inches, and/or 6 inches. According to various embodiments, ID is between 1 and 24 inches. According to various embodiments, OD is larger than 2 inches, 3 inches, 4 inches, 5 inches, 6 inches, and/or 8 inches. According to various embodiments, OD is between 2 and 29 inches. OD may match dimension A₁ in ANSI B5.9-1967 based on the type of spindle to be created.

As shown in FIG. 1, the collar 30 has an axial length L. According to various embodiments, L is larger than ½ inch, 1 inch, 1.5 inches, 2 inches, and/or 3 inches. According to various embodiments, L is between ½ inch and 12 inches, and/or between 1 inch and 6 inches.

The inner face of the collar 30 and mating outer face of the spindle adapter body 20 may be tapered/frusta-conical to improve the precise and accurate seating of the collar 30 onto the spindle adapter body 20.

In the illustrated embodiments, the collar 30 and front of the spindle adapter body 20 together form a spindle face. According to an alternative embodiment of the present invention, the frusta-conical surface 20h of the spindle adapter body 20 could be formed as part of the collar 30, rather than part of the spindle adapter body 20. In such an embodiment, the outer circumferential surface of the nose portion of the spindle adapter body could be cylindrical.

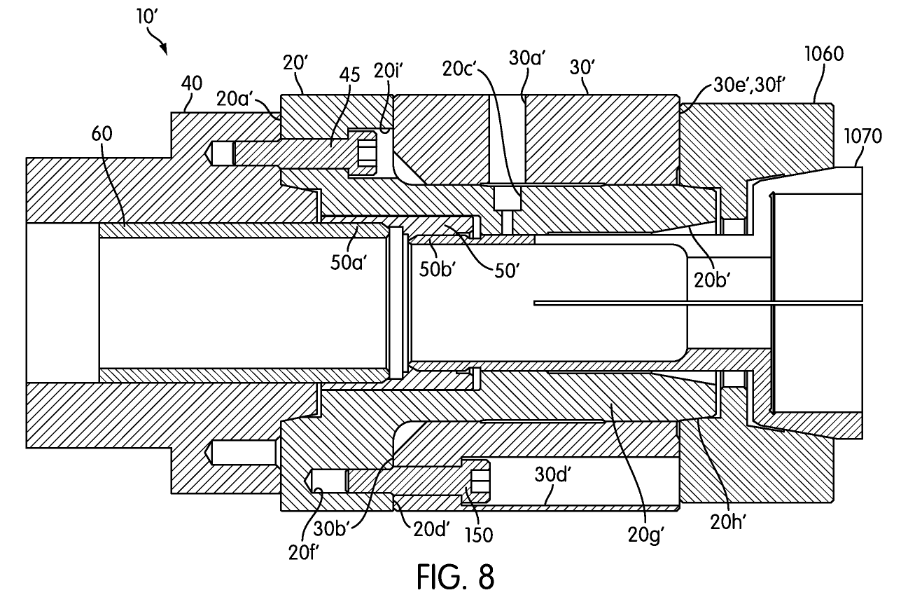

As shown in FIG. 1, the inner face of the collar 30 and mating outer face of the spindle adapter body 20 include a stepped shoulder that provides additional thickness to the spindle adapter body 20 in the region of the forward end of the bore for the link-up adapter. Depending on the sizes of various parts of the spindle adapter body 20 (e.g., diameter of the link-up adapter bore, L, ID, etc.), the stepped shoulder may be eliminated if the spindle adapter body 20 is sufficiently strong absent the shoulder (for example, as illustrated in the adapter 10′ illustrated in FIG. 8). Alternatively, the stepped shoulder may be replaced by a sloping shoulder.

While various of the illustrated and described spindles and spindle mounts for mounting the step closer 1060 (or other device) to the adapter 10 and mounting the adapter 10 to a machine spindle 40 utilize particular mounting faces (e.g., flat axial surface and frusta-conical surface) and bolts, a variety of alternatives may be used without deviating from the scope of the present invention (e.g., omission of any one or more features of the spindles and spindle mounts (e.g.; omission of the frusta-conical surface); use of screws rather than bolts; use of fasteners other than bolts; etc.).

According to one or more embodiments of the present invention, the collet adapter 10 is manufactured in manner that provides a high precision and accuracy connection between the adapter 10 and the step chuck assembly 1050. For example, the forward shoulder 30f of the collar 30 and frustoconical surface 20h of the spindle adapter body 20 may be machined while the collar 30 is mounted to the spindle adapter body 20. As a result, the shoulder 30f and surface 20h are precisely and accurately positioned relative to each other when the collar 30 is mounted to the adapter body 20. When the step collet closer 1060 is mounted to the adapter 10, the step collet closer 1060 engages the shoulder 30f and surface 20h to provide a high precision, high accuracy connection. After such machining, the collar 30 and spindle adapter body 20 are kept together as a mated pair for use, sale, etc. Labels, markings, or other indicia 200 (e.g., stamped serial numbers) may be used to associate mated pairs of collars 30 and spindle adapter bodies 20 with each other.

Hereinafter, use of the collet adapter 10 is described with reference to FIGS. 1 and 2. An operator mounts the link-up adapter 50 to the drawbar 60 and mounts the spindle adapter 20 to the spindle 40. As shown in FIG. 2, to use a standard, non-step collet 1020, the operator mounts the collet 1020 to the link-up adapter 50. The operator may remove the collar 30 from the spindle adapter body 20 or not attach the collar 30 at all (particularly if tool clearance requires). The operator mounts a work piece to the collet 1020 and uses the machine to work on the work piece. Removal of the collar 30 provides greater radial tool access to the nose portion 20g and the work piece. In fact, removal of the collar 30 may facilitate working operations that would be difficult or impossible if the collar 30 were mounted to the spindle adapter body 20. For example, removal of the collar 30 may enable the machine to be used in a manner that would create a physical interference with the collar 30 if the collar 30 were mounted to the spindle adapter body 20 (e.g., if part of a tool, tool holder, turret, etc. moves into the space that would be occupied by the collar 30 if the collar 30 were mounted to the spindle adapter body 20).

As shown in FIG. 1, to use the step collet 1070, the operator mounts the collar 30 to the spindle adapter body 20 and mounts the step chuck closer 1060 to the collar 30. The operator then mounts the step collet 1070 to the link-up adapter 50 and mounts a work piece to the step chuck assembly 1050. The operator then uses the machine to work on a second work piece while the second work piece that is mounted to the step chuck assembly 1050, the step chuck closer 1060 of which is mounted to the collar 30.

As shown in FIG. 1, when assembled/mounted together, the drawbar 60, link-up adapter 50, collet 1020 or 1070, spindle adapter body 20, collar 30, and step chuck closer 1060 (if used) are coaxial with each other about the longitudinal axis 140 of rotation of the adapter 10. As used throughout this specification and claims, the term forward direction means the direction along the axis 140 toward a forward end of the adapter 10 (i.e., to the right as shown in FIGS. 1 and 2 and out of the page as shown in FIG. 3). The spindle adapter body 20 and collar 30 are generally rotationally symmetric about the axis 140 (with various exceptions such as the presence of various radial and axial holes 30a, 20c, 20f, 30d, 30g, the alignment features 20e, 30c, etc.).

FIG. 8 illustrates a collet adapter 10′ that is generally similar to the collet adapter 10 discussed above. Accordingly, components of the collet adapter 10′ will be identified by the reference number of their similar components in the collet adapter 10, with the addition of a′. The collet adapter 10′ includes a spindle adapter body 20′ with a spindle mount 20a′, a collet seat 20b′, a radial hole 20c′, a collar mount 20d′, bolt holes 20f′, a nose portion 20g′, a frusta conical surface 20h′, and bolt holes 20i′, a collar 30′ with a radial hole 30a′, a spindle adapter body mount 30b′, bolt holes 30d′, a mounting surface 30e′, and a forward mounting shoulder 30f′, and a link-up adapter 50′ with a drawbar mount 50a′ and a collet mount 50b′. The outer surface of the nose portion 20g′ is generally cylindrical (except for the frusta conical surface 20h′), as opposed to the stepped outer surface of the nose portion 20g of the adapter 10. Similarly, the inner surface of the collar 30′ is generally cylindrical, as opposed to the stepped inner surface of the collar 30. Alternatively, the inner surface of the collar 30′ and the outer surface of the nose portion 20g′ may have any other suitable shape (e.g., complimentary tapered and/or frusta conical surfaces) without deviating from the scope of the present invention.

While particular collets 1020 and step chuck assemblies 1050 are illustrated, one or more embodiments of the present invention may be used with a variety of other types of collets and step collets (e.g., ID or OD collets and step collets, dead length collets and step collets, etc.).

The foregoing illustrated embodiments are provided to illustrate the structural and functional principles of embodiments of the present invention and are not intended to be limiting. To the contrary, the principles of various embodiments of the present invention are intended to encompass any and all changes, alterations and/or substitutions within the spirit and scope of the following claims.

1. A collet adapter comprising:
a spindle adapter body having a spindle mount configured to removably mount to a spindle of a machine, the spindle adapter body having a collet seat with a tapered cam surface configured to mate with a collet; and
an adapter collar configured to removably mount to the spindle adapter body, the collar having a mounting shoulder configured to removably mount to and support a workholding device.

2. The collet adapter of claim 1, wherein the collet adapter comprises a spindle nose when the collar is mounted to the spindle adapter body, the mounting shoulder of the collar defining at least a portion of the spindle nose.

3. The collet adapter of claim 2, wherein the spindle nose comprises an ANSI spindle nose.

4. The collet adapter of claim 1, wherein there is greater radial tool access to a nose portion of the spindle adapter body when the collar is removed from the spindle adapter body than when the collar is mounted to the adapter body.

5. The collet adapter of claim 1, wherein the mounting shoulder comprises a step collet mounting shoulder that is configured to removably mount to and support a spindle mount of a step chuck closer that includes a tapered cam surface of a larger size than the tapered cam surface of the collet seat.

6. The collet adapter of claim 1, wherein the mounting shoulder has a larger diameter than a nose portion of the spindle adapter.

7. The collet adapter of claim 1, wherein a portion of the collar extends farther forward than or farther radially outward than any point on the spindle adapter body when the collar is mounted to the spindle adapter body.

8. The collet adapter of claim 1, wherein the mounting shoulder extends either farther forward than or farther radially outward than any point on the spindle adapter body when the collar is mounted to the spindle adapter body.

9. The collet adapter of claim 1, wherein the spindle adapter body comprises a nose portion that extends farther forward than the collar when the collar is mounted to the spindle adapter body.

10. The collet adapter of claim 1, wherein the spindle adapter body and collar have radial through holes that align when the collar is mounted to the spindle adapter body.

11. The collet adapter of claim 1, wherein:
the collar comprises a step chuck closer mount configured to removably mount to a step chuck closer;
the step chuck closer mount includes the mounting shoulder; and
the step chuck closer mount comprises a plurality of bolt holes in the mounting shoulder.

12. The collet adapter of claim 11, wherein the plurality of bolt holes are positioned in an A2-x mounting pattern and are each threaded.

13. The collet adapter of claim 1, wherein the spindle adapter body and collar comprise a mated pair that are specifically manufactured for use with each other.

14. The collet adapter of claim 13, wherein the spindle adapter body and collar each have indicia indicating that they are a mated pair.

15. The collet adapter of claim 1, wherein the spindle adapter body and collar are configured to only mount to each other in a single, predetermined, relative pivotal position about a longitudinal axis of the collet adapter.

16. The collet adapter of claim 1 in combination with a step chuck assembly, the step chuck assembly comprising:
a step chuck closer mounted to the collar, the step chuck closer comprising a cam surface; and
a step collet, the step collet having a cam surface that mates with the cam surface of the step chuck,
wherein the collar is mounted to the spindle adapter body.

17. (canceled)

18. The collet adapter of claim 1, wherein the spindle mount of the spindle adapter body comprises an ANSI spindle mount.

19. The collet adapter of claim 1, wherein the collar has an axial length of at least ½ inch.

20. The collet adapter of claim 1, wherein:
the spindle adapter body comprises
a machine spindle mount configured to removably and securely mount to a spindle of a machine, and
a collar mount; and
the collar comprises an adapter body mount that is configured to removably and securely mount to the collar mount of the spindle adapter body.

21. The collet adapter of claim 20, wherein:
the collar mount comprises at least one bolt hole in the adapter body; and
the adapter body mount comprises at least one bolt hole in the collar, the at least one bolt hole in the collar being configured to align with the at least one bolt hole in the adapter body when the collar is disposed in a mounting position relative to the adapter body to facilitate at least one bolt extending into the at least one bolt hole in the adapter body and the at least one bolt hole in the collar.

22. A collet adapter comprising:
a spindle adapter body having a spindle mount configured to removably mount to a spindle of a machine, the spindle adapter body having a collet seat with a tapered cam surface configured to mate with a collet; and
an adapter collar configured to removably mount to the spindle adapter body, the collar having a mounting shoulder,
wherein, when the adapter collar is mounted to the spindle adapter body, the adapter forms a spindle nose for mounting a spindle mount of a device thereto, the mounting shoulder of the collar forming at least a part of the spindle nose.

23. The adapter of claim 22, wherein the spindle adapter body itself does not form a spindle nose for mounting a spindle mount thereto.

24. The adapter of claim 22, wherein:
the spindle nose comprises an ANSI spindle nose,
when the adapter collar is mounted to the spindle adapter body, the mounting shoulder of the collar forms at least a part of the ANSI spindle mount, and
the spindle adapter body itself does not form an ANSI spindle nose.

25. The adapter of claim 24, wherein:
the ANSI spindle nose comprises an A2-x spindle nose;
the collar has an A2-x bolt hole pattern in its forward face, the A2-x bolt hole pattern defining a portion of the A2-x spindle nose; and
a nose portion of the spindle adapter body has a frusta-conical surface that defines a portion of the A2-x spindle nose.

26. A method of manufacturing a collet adapter that comprises a spindle adapter body having a spindle mount configured to removably mount to a spindle of a machine, the spindle adapter body having a collet seat with a tapered cam surface configured to mate with a collet; and an adapter collar configured to removably mount to the spindle adapter body, the collar having a mounting shoulder configured to removably mount to and support a workholding device, the method comprising:
while the collar is mounted to the spindle adapter body, machining a forward axial face of the collar to form the shoulder.

27. The method of claim 26, further comprising putting the spindle adapter body and collar together for use or sale as a matched pair.

28. The method of claim 26, further comprising, while the collar is mounted to the spindle adapter body, machining a tapered surface of the spindle adapter body, the machined tapered surface being configured to work in conjunction with the shoulder to properly locate a workholding device on the collet adapter.

29-31. (canceled)
